(19) United States
(12) Patent Application Publication
(10) Pub. No.: US 2020/0136824 A1
(43) Pub. Date: Apr. 30, 2020

(54) ASYMMETRIC ENCRYPTION SCHEME FOR SECURE DATA TRANSMISSION

(71) Applicant: MASTERCARD INTERNATIONAL INCORPORATED, Purchase, NY (US)

(72) Inventors: John Allen, Newcastle (IE); Peter Groarke, Dublin (IE); Vladut Druta, Dublin (IE)

(21) Appl. No.: 16/171,011

(22) Filed: Oct. 25, 2018

(51) Int. Cl. H04L 9/32; H04L 9/30; H04L 9/08

(52) U.S. Cl. CPC H04L 9/3213; H04L 9/085; H04L 9/0877; H04L 9/30

(57) ABSTRACT

A data access computing device is provided. The data access computing device receives a token request from a user computing device, generates a secret value unique to the token request, encrypts the secret value using a private key associated with the data access computing device, encrypts the secret value using a public key associated with the relying party to generate a sharing token, transmits the sharing token to the user computing device, receives a payload encrypted using a private key associated with the relying party from a relying party computing device, where the payload includes the secret value and a nonce value, decrypts the payload using the to recover the nonce value and the secret value, retrieves the at least one user data element from the database based on the secret value, and transmits the at least one user data element to the relying party computing device.

### BACKGROUND

This disclosure relates generally to secure data transmission, and more specifically, to encrypting and verifying transmissions of user data.

Consumers increasingly expect delivery and subscription services from merchants. For example, consumers may place a recurring order for common household items, or order delivery from a new restaurant. However, organizing and fulfilling these purchased services is dependent upon accurate transmission of unstructured data and/or data without integrated verification options (e.g., checksum values). Frequently, addresses and phone numbers may still be valid with only minor errors in transmission. For example, 400 W. 1^{st} St. and 400 E. 1^{st} St. may both be valid addresses.

At least some consumers may move residences from one location to another location on an annual or more frequent basis, leading to frequent changes in user data (e.g., addresses, phone numbers, etc.). Outdated user data may result in costly incorrect deliveries and missed notifications. Obtaining updated contact information may be excessively time consuming when the service provider only has outdated contact information to work from.

There is a need for users to accurately provide user data to third parties without manually copying information and/or providing user data over an unsecure communications channel. Further, repeatedly updating user data stored redundantly with multiple third parties may be time consuming and/or error prone. There is also a need to reduce redundancy in user data stored with individual parties.

### BRIEF DESCRIPTION

In one aspect, a data access computing device including a processor in communication with a database, where the database stores a plurality of user data elements associated with a user is provided. The data access computing device receives a token request from a user computing device, the token request including an authentication key, wherein the token request identifies a relying party and at least one user data element of the user to be shared with the relying party. The data access computing device further generates, in response to validating the authentication key, a secret value unique to the token request, associates, in the database, the secret value with the at least one user data element, encrypts the secret value in a first encryption layer using a private key A associated with the data access computing device to generate an A-encrypted secret value, encrypts the A-encrypted secret value in a second encryption layer using a public key B associated with the relying party to generate a sharing token, transmits the sharing token to the user computing device, receives a payload encrypted using a private key B associated with the relying party from a relying party computing device, where the payload includes the A-encrypted secret value and a nonce value and the private key B is complementary to the public key B, decrypt the payload using the public key B to recover the nonce value and the A-encrypted secret value, decrypt the A-encrypted secret value using a public key A to recover the secret value, wherein the public key A is complementary to the private key A, retrieve the at least one user data element from the database based on the secret value, and transmit the at least one user data element to the relying party computing device.

In another aspect, a computer-implemented method for secure data transmission is provided. The method is implemented using a data access computing device including a processor in communication with a database. The method includes receiving a token request from a user computing device, the token request including an authentication key, where the token request identifies a relying party and at least one user data element of the user to be shared with the relying party. The method further includes generating, in response to validating the authentication key, a secret value unique to the token request, associating, in the database, the secret value with the at least one user data element, encrypting the secret value in a first encryption layer using a private key A associated with the data access computing device to generate an A-encrypted secret value, encrypting the A-encrypted secret value in a second encryption layer using a public key B associated with the relying party to generate a sharing token, transmitting the sharing token to the user computing device, receiving a payload encrypted using a private key B associated with the relying party from a relying party computing device, wherein the payload includes the A-encrypted secret value and a nonce value, and where the private key B is complementary to the public key B, decrypting the payload using the public key B to recover the nonce value and the A-encrypted secret value, and decrypting the A-encrypted secret value using a public key A to recover the secret value, where the public key A is complementary to the private key A, retrieving the at least one user data element from the database based on the secret value, and transmitting the at least one user data element to the relying party computing device.

In another aspect, a non-transitory computer readable storage media having computer-executable instructions is provided. When executed by a data access computing device having a processor coupled to a database, the computer-executable instructions cause the processor to receive a token request from a user computing device, the token request including an authentication key, where the token request identifies a relying party and at least one user data element of the user to be shared with the relying party. The computer-executable instructions further cause the processor to generate, in response to validating the authentication key, a secret value unique to the token request, associate, in the database, the secret value with the at least one user data element, encrypt the secret value in a first encryption layer using a private key A associated with the data access computing device to generate an A-encrypted secret value, encrypt the A-encrypted secret value in a second encryption layer using a public key B associated with the relying party to generate a sharing token, transmit the sharing token to the user computing device, receive a payload encrypted using a private key B associated with the relying party from a relying party computing device, where the payload includes the A-encrypted secret value and a nonce value, and the private key B is complementary to the public key B, decrypt the payload using the public key B to recover the nonce value and the A-encrypted secret value, decrypt the A-encrypted secret value using a public key A to recover the secret value, where the public key A is complementary to the private key A, retrieve the at least one user data element from the database based on the secret value, and transmit the at least one user data element to the relying party computer system.

In yet another aspect, a relying party computing device including at least one processor in communication with a memory is provided. The relying party computing devices requests at least one user data element from a user, receives a sharing token from a user computing device associated with the user, the sharing token including a secret value encrypted in a first encryption layer using a private key A associated with a data access computing device, and in a second encryption layer using a public key B associated with the relying party computing device, decrypts the sharing token using a private key B to recover to the A-encrypted secret value, where the private key B is complementary to the public key B, generates a nonce value, encrypts the A-encrypted secret value and the nonce value together using the private key B to generate a payload, transmits the payload to the data access computing device, and receives, in response to the transmission of the payload, the at least one user data element.

### BRIEF DESCRIPTION OF THE DRAWINGS

FIG. 1 is a schematic diagram illustrating an example data access computing system.

FIG. 2 is a simplified block diagram illustrating network data flow between a data access computing device and a user computing device of the data access computing system shown in FIG. 1.

FIG. 3 is a simplified block diagram illustrating network data flow between the data access computing device and a relying party computing device of the data access computing system shown in FIG. 1.

FIG. 4 illustrates an example configuration of the user computing device of the data access computing system shown in FIG. 1.

FIG. 5 illustrates an example configuration of the data access computing device of the data access computing system shown in FIG. 1.

FIG. 6 illustrates an example configuration of the relying party computing device of the data access computing system shown in FIG. 1.

FIG. 7 is a schematic view of the user computing device of the data access computing system shown in FIG. 1.

FIG. 8 is a flowchart illustrating an example method for secure data transmission using the data access computing device of the data access computing system shown in FIG. 1.

FIG. 9 is a flowchart illustrating an example method for securely retrieving at least one user data element using a sharing token using the relying party computing device of the system shown in FIG. 1.

### DETAILED DESCRIPTION

The following detailed description illustrates embodiments of the disclosure by way of example and not by way of limitation. The description enables one skilled in the art to make and use the disclosure. It also describes several embodiments, adaptations, variations, alternatives, and uses of the disclosure, including what is presently believed to be the best mode of carrying out the disclosure.

A data access computing device is described herein. In the example embodiment, the data access computing device is configured to generate sharing tokens. A sharing token is encrypted by the data access computing device using at least two different encryption keys, such that the origin of the sharing token may be verified and the sharing token is secure while being transmitted over unsecure communication channels. In the example embodiment, the sharing token is transmitted by the data access computing device to a relying party (e.g., a relying party computing device) through a user computing device. For example, a user may first receive the sharing token and then provide it to the relying party.

The sharing token may be used by the relying party to subsequently access sensitive user data over a secure channel (e.g., a virtual private network connection). Further, the sharing token may be reused to periodically access the sensitive user data as needed to avoid redundantly storing user data and/or relying on outdated user data. In at least some, embodiments, the user data is personally identifiable information (PII), and the data access computing system obtains opt-in informed consent from users for data usage by the system consistent with applicable consumer protection laws and privacy regulations. Users may be provided with an opportunity to control whether such information is collected or to control whether and/or how such information is used. In addition, certain data may be processed in one or more ways before it is stored or used, so that personally identifiable information is removed and/or anonymized.

For example, a user may sign up online for television service, using a mobile device and a potentially unsecure connection (e.g., public wireless internet). In the example embodiment, the mobile device transmits the encrypted sharing token over the unsecure connection to complete the sign up process. Subsequently, the television service may retrieve user data (e.g., mailing address, physical address, email address, etc.) using the encrypted sharing token from the data access computing device. In the example embodiment, the user data is retrieved over a secure connection.

In another example, a user may request home delivery from a furniture merchant. A mobile device is used to transmits the encrypted sharing token to the relying party using a QR (quick read) code. The furniture merchant, using a relying party computing device, may scan the QR code to receive the encrypted sharing token, and further use the encrypted sharing token to retrieve a delivery address over a secure connection (e.g., a virtual private network connection) from the data access computing device.

In some known systems, these examples may have previously required the user to enter the user data, including personally identifiable information, into web pages provided by each corresponding relying party, and the user data may have been transmitted to each relying party over an unsecure communication channel. Moreover, each relying party formerly may have stored the user data, including personally identifiable information, separately on a corresponding relying party computing device, increasing the vulnerability of the user data to compromise via breach of any one of the multiple relying party computing devices, and making it more difficult for the user to ensure that each relying party updates the applicable user data in response to any changes. By contrast, the system of the present disclosure requires the user to transmit only a sharing token, containing no personally identifiable information, to each relying party over any convenient but potentially unsecure communications channel. Each relying party then uses the sharing token as needed to retrieve the current user data from a single repository through the data access computing device. Moreover, in some embodiments, the actual user data may be retrieved over a secure connection (e.g., a virtual private network connection) between the relying party and the data access computing device. Participation in the present system enables the relying party to access current/updated user data from the single repository on an as-needed basis (subject to the type of authorization provided by the user), obviating any need for each relying party to store the user data. Thus, using the system of the present disclosure, the user data, including personally identifiable information, is much less likely to be compromised during transmission and/or through breach of a relying party's computer system, and the relying party has a greatly reduced risk of acting on stale or outdated user data.

In certain embodiments, the encrypted sharing token may include an expiration time. For example, the furniture merchant may be granted short term (e.g., 1 hour, 1 day) access to user data to retrieve a delivery address data element. In another example, the television service provider may be granted long term (e.g., 6 months, 1 year) access to the user data to periodically retrieve the user data, such as a current mailing address for the consumer.

In the example embodiment, the sharing token is generated using at least two layers of asymmetric cryptography. A first layer is used to secure a secret value, and to verify the origin of the sharing token. The second layer is used to protect the sharing token in transit over unsecure networks, and to prevent the sharing token from being fraudulently reused in a replay attack. For example, the sharing token may be intercepted by an attacker. However, the second layer of encryption prevents the attacker from replaying the sharing token to the data access computing device to retrieve user data.

More specifically, in some embodiments, the relying party must decrypt the second layer of encryption, add a nonce value, and encrypt the sharing token to restore the second layer. In other words, the relying party must remove the outer layer of encryption to activate the sharing token, however, the inner layer of encryption may remain intact to secure the secret value. In the example embodiment, the nonce value is randomly generated and uniquely identifies an instance of the sharing token. In an alternate embodiment, the nonce value is generated based on the current time, and indicates the time the sharing token was activated (e.g., received by the relying party). The replacement second layer of encryption is configured such that it may be decrypted by the data access computing device. For example, it may be encrypted using the public key of the data access computing device, where the data access computing device exclusively stores the complementary private key.

The inner first encryption layer may be removed by the data access computing device after the modified (e.g., including the nonce value) sharing token is received from the relying party. In the example embodiment, the data access computing device is configured to decrypt the second encryption layer, verify the nonce value, decrypt the first encryption layer, and verify the secret value. In other words, the data access computing device verifies that the sharing token was properly activated by the relying party using the nonce value, and that the sharing token was properly generated using the secret value.

Each layer is encrypted using an encryption key distinct from the decryption key. Keys used for either encryption or decryption may be labeled as public or private keys. For example, given a complementary public/private key pair, data may be encrypted with either the public or private key, and the data may be decrypted with the alternate key.

The relying party computing device is configured to receive the sharing token from the user computing device. In one embodiment, the relying party computing device includes a camera interface configured to scan a quick read code including the sharing token. In another embodiment, the relying party computing device is configured to transmit a webpage to the user computing device, wherein the webpage is configured to cause the user computing device to obtain the sharing token. For example, the webpage may automatically retrieve and transmit the sharing token. In yet another embodiment, the relying party computing device is configured to transmit a webpage to the user computing device, wherein the webpage includes an interactive form field to receive the sharing token. For example, the webpage may prompt a user to enter an alphanumeric sharing token.

In certain embodiments, a user may restrict the sharing token, to limit the timeframe in which the relying party can retrieve user data from the data access computing device. In one embodiment, a sharing token request may include an expiration time, such that generated secret value is invalid after the expiration time. For example, the user may specify a one week timeframe for sharing token validity, such that the relying party has limited access to the user data.

The technical problems addressed by the disclosure include at least one of: (i) data, such as personally identifiable information, being fraudulently intercepted when transmitted over unsecure communication channels, (ii) unauthorized data access using intercepted authentication data (e.g., replay attacks), (iii) decreased data security due to multiple copies of sensitive data being stored across disparate systems, (iv) complex errors due to reliance on inaccurate or outdated data, including where the data may not be algorithmically validated or error checked.

The resulting technical benefits achieved by the systems and methods of the disclosure include at least one of: (i) network data security (iii) reduced risk of sensitive data interception on unsecure networks, (iii) sensitive data transmission moved to secure network, (iv) detection of replay attacks, (v) reduced duplication and redundant storage of user data, including personally identifiable information, in multiple computing systems, and (vi) increased data accuracy due to centralization of user data in a single repository.

In one embodiment, a computer program is provided, and the program is embodied on a computer-readable medium. In an example embodiment, the system is executed on a single computer system, without requiring a connection to a server computer. In a further example embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a WINDOWS® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database implementation (e.g., relational, document-based) may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

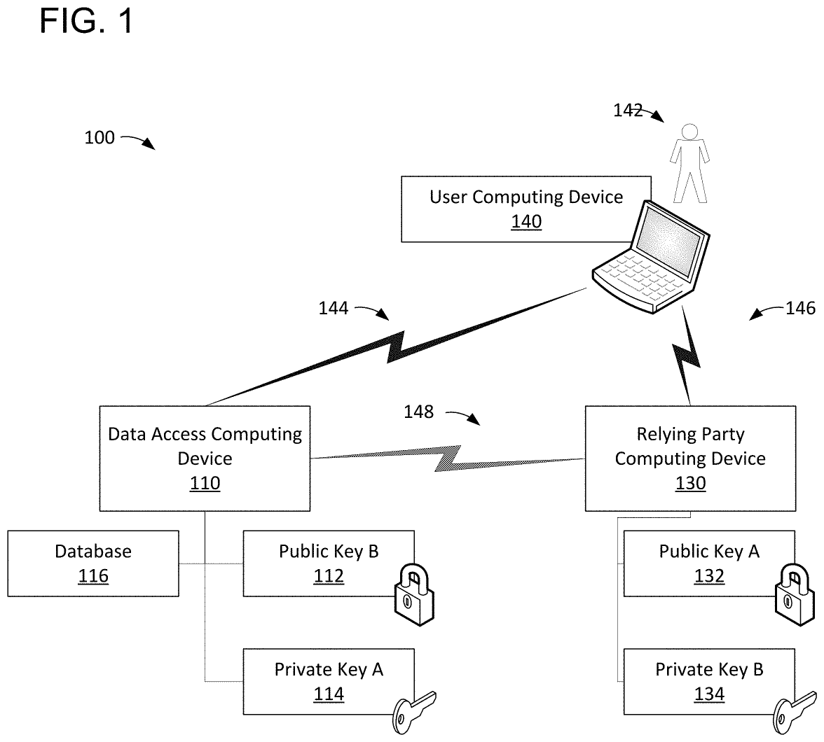

FIG. 1 is a schematic diagram illustrating an example data access computing system. Data access computing system 100 includes data access computing device 110 or “DA computing device” 110, relying party computing device 130, and user computing device 140. DA computing device 110 stores data, including personally identifiable information in some embodiments, on behalf of user 142 in database 116. For example, database 116 may store primary account numbers (e.g., debit card numbers, credit card numbers), email addresses, mailing addresses, phone numbers, and any other personal data associated with user 142. The aggregated data associated with user 142 stored by DA computing device 110 may be referred to as “a digital persona” or user data of user 142.

Third parties, such as relying party 130, may request user data from user 142. Directly communicating user data (e.g., a mailing address) by user 142 to relying party computing device 130 may be time consuming and error-prone. Additionally, it may be unsecure for user 142 to directly provide the requested user data to relying party computing device 130. For example, the communication channel may be public or unsecured. Instead, in the example embodiments user 142 may authorize relying party computing device 130 to retrieve user data from DA computing device 110 over a secure channel and potentially at a later time.

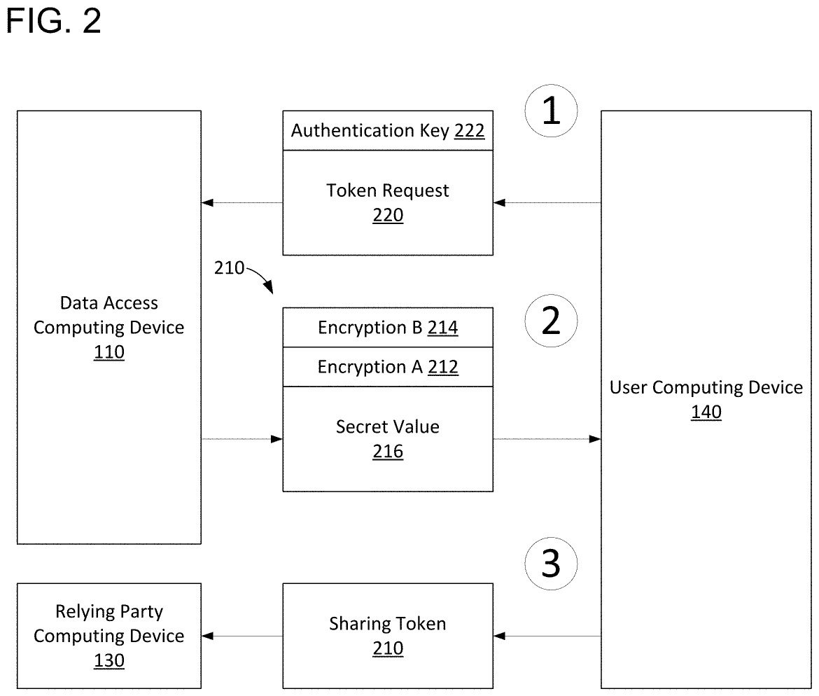

More specifically, user computing device 140 transmits sharing token 210 (shown in FIG. 2) to relying party computing device 130 using connection 146, a local and/or transient connection. For example, sharing token 210 may be encoded as a QR code by user computing device 140, and relying party computing device 130 may scan the QR code using a camera interface.

Sharing token 210 is initially generated by DA computing device 110 using a public/private key architecture, as shown in FIG. 2. User computing device 140 receives sharing token 210 from DA computing device 110 over connection 144, which may be, for example, an internet connection. Key A is associated with DA computing device 110, thus private key A 114 is stored by DA computing device 110. Relying party computing device 130 stores the public counterpart to private key A, public key A 132. Additionally, key B is associated with the relying party, thus private key B 134 is stored by relying party computing device 130. Public key B 112 is accessible by DA computing device 110. In certain embodiments, public keys (e.g., public key B 112, public key A 132) may not be directly stored by DA computing device 110 and/or relying party computing device 130. In one embodiment, public keys are retrieved as needed from a key server, key database, and/or certificate authority.

After receiving sharing token 210, relying party computing device 130 may use sharing token 210 to retrieve user data associated with user 142 from DA computing device 110. However, relying party computing device 130 does not need to be in communication with DA computing device 110 at the time relying party computing device 130 receives sharing token 210. For example, relying party computing device 130 may be disconnected from the Internet at the time sharing token 210 is received. Relying party computing device 130 may use sharing token 210 at a later time, e.g. to retrieve the user data after reconnecting to the Internet and/or after establishing a secure communication channel 148 (e.g., a virtual private network connection) with DA computing device 110. Relying party computing device 130 may include a secure back-end processing system in communication with DA computing device 110, and a separate device in direct communication with user computing device 140 that forwards received sharing token 210 to the secure back-end processing system. For example, relying party computing device 130 may include a publically accessible point-of-sale system or website that forwards the sharing token to the secure back-end processing system for immediate or later communication to DA computing device 110.

FIG. 2 is a simplified block diagram illustrating network data flow between DA computing device 110 and user computing device 140. To obtain sharing token 210, user computing device 140 generates and transmits token request 220 to DA computing device 110. In the example embodiment, sharing token 210 is configured to authorize access by a designated relying party computing device 130 to one or more selected elements of the user data of user 142, rather than to all user data of user 142. For example, token request 220 may include identifiers of selected elements of the user data to be shared. For example, token request 220 may include “address1;email2;” to indicate that a primary mailing address and a secondary email address are the only data elements that user 142 intends to share with the designated relying party computing device 130. Moreover, user computing device 140 may configure token request 220 to share specific types of data (e.g., any email address but no phone number) and/or specific instances of data (e.g., a specific email address) with the designated relying party computing device 130.

Token request 220 further includes authentication key 222, which identifies user 142 and user computing device 140 to DA computing device 110. For example, authentication key 222 may be generated by a mobile application executing on user computing device 140, or authentication key 222 may have been generated when user 142 logged into a website associated with DA computing device 110 using user computing device 140. In certain embodiments, token request 220 includes a relying party identifier that may be used to identify the designated relying party computing device 130. For example, token request 220 may identify a merchant and/or a public key associated with a merchant (e.g., public key B 112).

DA computing device 110 generates sharing token 210 in response to token request 220. Sharing token 210 includes at least two levels of encryption, based at least in part on a public/private encryption scheme (e.g., asymmetric encryption, RSA encryption, Public-key cryptography, etc.) As used herein, RSA refers Rivest-Shamir-Adleman encryption using a public-private key pair. In the example embodiment, a random value, designated secret value 216, is generated to identify sharing token 210. For example, secret value 216 is a universally unique identifier (UUID) and/or a globally unique identifier (GUID). In the example embodiment, secret value 216 is associated in database 116 directly with the at least one user data element requested in token request 220, rather than generally with user 142. In other words, secret value 216 is not associated in database 116 with others of the plurality of user data elements of user 142, such that secret value 216 is usable by relying party computing device 130 to obtain solely the user data elements specified in the token request, and not usable by relying party computing device 130 (or a fraudulent impersonator of relying party computing device 130) to obtain any additional user data elements.

First, secret value 216 is encrypted with private key A 114, the private key of data access computing device 110, in a first layer of encryption illustrated as encryption A 212. Encryption A 212 is reversible using public key A 132 of data access computing device 110. Encryption A 212 indicates that secret value 216 was generated (i.e., signed) by a system storing private key A 114. In other words, encryption A 212 confirms that sharing token 210 was properly generated by DA computing device 110, such that a fraudulent sharing token not generated by DA computing device 110 may be identified.

A-encrypted secret value 216 (i.e., secret value 216 after encryption A 212 is applied) is encrypted with the public key of the relying party (public key B 112), in a second layer of encryption designated encryption B 214 to generate sharing token 210. Encryption B 214 is reversible using the complementary private key of the relying party (private key B 134), such that secret value 216 is only accessible by a system storing private key B 134. In other words, encryption B 214 confirms that only relying party computing device 130 will be able to access secret value 216.

DA computing device 110 then transmits sharing token 210, including the two layers of encryption, to user computing device 140. For example, sharing token 210 may be transmitted securely over unsecure communication channels (e.g., a public wireless network, the Internet), due to the two layers of encryption.

User computing device 140 transmits sharing token 210 to relying party computing device 130. In the example embodiment, user computing device 140 transmits sharing token 210 using a transient and/or local connection. Moreover, user computing device 140 may be configured to encode sharing token 210 before transmission. In one embodiment, user computing device 140 encodes sharing token 210 as a quick read (QR) code, which may be scanned using a camera associated with relying party computing device 130. In another embodiment, user computing device 140 encodes sharing token 210 as an audio tone, which may be received using a microphone by relying party 130. In yet another embodiment, user computing device 140 may transmit sharing token 210 using a Bluetooth low energy connection to relying party 130.

In an alternate embodiment, user computing device 140 transmits sharing token 210 to relying party 130 using a web application or mobile application. For example, user 142 may paste sharing token 210 into a webpage generated by relying party computing device 130. For example, a webpage generated by relying party computing device 130 may include a HTML (hypertext markup language) form field such that user 142 may submit sharing token 210 using user computing device 140.

In alternate embodiments, user computing device 140 transmits sharing token 210 in any suitable fashion.

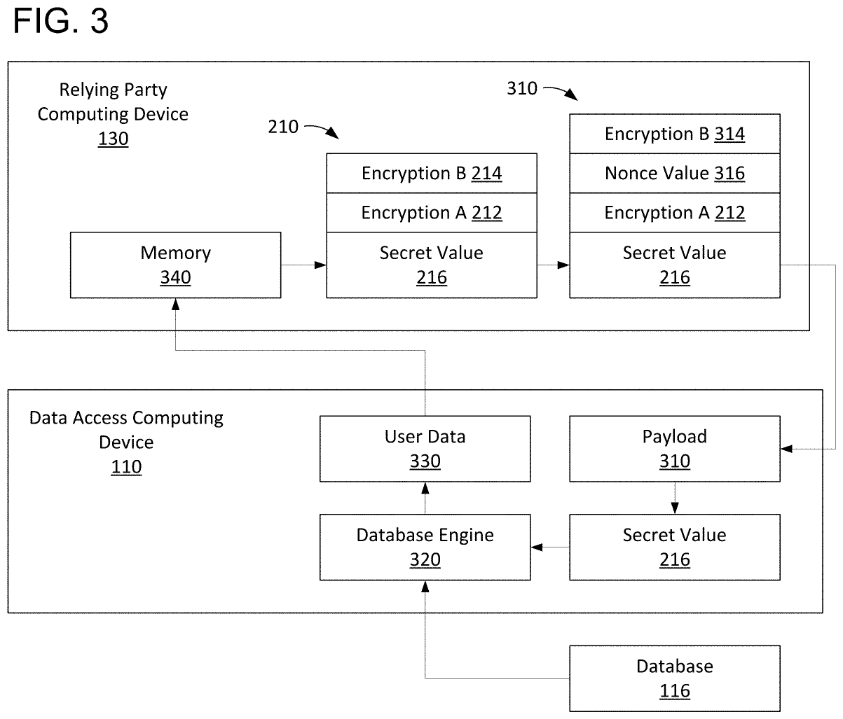

Relying party 130 may store sharing token 210 in memory 340 (shown in FIG. 3) before subsequently requesting the user data, authorized by sharing token 210.

FIG. 3 is a simplified block diagram illustrating network data flow between DA computing device 110 and relying party computing device 130. As described above, relying party computing device 130 may include a plurality of communicatively coupled computing devices, such as a point-of-sale or front-end device that receives sharing token 210 from user computing device 140 and a secure back-end processing system in communication with DA computing device 110.

In the example embodiment, relying party 130 retrieves sharing token 210 from memory 340, and reverses encryption B 214 using private key B 134 to recover the A-encrypted secret value 216. Notably, third parties lacking access to private key B 134 cannot reverse encryption B 214 and, thus, cannot recover the A-encrypted secret value 216. In some embodiments, relying party computing device 130 is configured to also use public key A 132 to validate that sharing token 210 was generated by DA computing device 110. In other words, if the recovered A-encrypted secret value 216 is susceptible to decryption using public key A 132, then sharing token 210 must have been generated by a system with access to private key A 114, thus validating that sharing token 210 was generated by DA computing device 110. Alternatively, relying party computing device 130 does not validate sharing token 210 using public key A. For example, DA computing device 110 later validates sharing token 210 as described below.

In the example embodiment, relying party computing device 130 generates a one-time-use nonce value 316 (e.g., based on the current time) and appends nonce value 316 to the A-encrypted secret value 216. Nonce value 316 may be used to enable detection and/or prevention of replay attacks, that is, attacks in which a sharing token is intercepted and reused fraudulently. After adding nonce value 316 to A-encrypted secret value 216, relying party computing device 130 re-encrypts the modified sharing token 210 using private key B 134, designated in FIG. 3 as encryption B 314, to generate payload 310. Encryption B 314 is reversible using public key B 112. In other words, encryption B 314 verifies that sharing token 210 was processed by relying party computing device 130, rather than by an unauthorized third party.

After re-encryption, relying party computing device 130 transmits payload 310 to DA computing device 110. In the example embodiment, relying party computing device 130 transmits payload 310 over secure communication channel 148. Alternately, relying party computing device 130 transmits payload 310 over any suitable communication channel, such as an unsecured network (e.g., unsecured Internet connection). In one embodiment, payload 310 is transmitted to an access sharing web service provided by DA computing device 110. More specifically, relying party computing device 130 transmits a HTTP (hypertext transfer protocol) request including payload 310 to DA computing device 110. In response to receiving payload 310, DA computing device 110 verifies payload 310, retrieves the at least one user data element 330, and transmits at least one user data element 330 to relying party computing device 130, as described in more detail below.

In some embodiments, secret value 216 is associated in database 116 with a number-of-uses restriction. For example, secret value 216 may enable sharing token 210 generated therefrom for multiple uses by relying party computing device 130. For example, relying party computing device 130 may periodically check for updates in the at least one user data element 330. In such embodiments, nonce value 316 is generated separately for each payload generated from multi-use sharing token 210, thereby preventing a replay attack using one of payloads 310 disguised as a later periodic request. For another example, secret value 216 may restrict sharing token 210 generated therefrom to a single use by relying party computing device 130. Thus, the number-of-uses restriction may implement an authorization of user 142 as to the type of access granted to each relying party computing device 130.

Additionally or alternatively, secret value 216 is associated in database 116 with a limited authorization time window. In one embodiment, the nonce value includes a time stamp (e.g., UNIX time) indicating when payload 310 was generated by relying party computing device 130. DA computing device 110 may be configured to validate the time embodied in received nonce value 316 against the stored authorization time window, and to reject untimely payloads 310. Additionally or alternatively, DA computing device 110 may be configured to validate the time embodied in received nonce value 316 against a time that DA computing device 110 receives payload 310, and to reject stale payloads 310 as likely to be fraudulent.

As discussed above, nonce value 316 may prevent replay attacks, where payload 310 is replayed from a fraudulent relying party. The nonce value is used to verify that the received payload is unique, that is, that the payload is not being replayed (e.g., presented multiple times), by comparing the nonce value to previously received nonce values. If DA computing device 110 identifies nonce value 316 as one that has been previously received, that would indicate that the payload 310 was previously presented. Nonce value 316 may also be used to enhance the security of payload 310 in other ways. For example, adding additional data to payload 310 via nonce value 316 may increase the complexity of determining (e.g., cracking) the keys required to decrypt payload 310.

In the example embodiment, after receiving payload 310, DA computing device 110 reverses encryption B 314 using public key B 112. In other words, DA computing device 110 verifies that payload 310, and the included nonce value, were “signed” and/or generated using the private key (private key B 134) associated with relying party computing device 130. DA computing device 110 next reverses encryption A 212 using public key A to recover secret value 216, originally generated by DA computing device 110. In other words, DA computing device 110 confirms that secret value 216 stored in payload 310 was originally encrypted by DA computing device 110 using the appropriate private key (private key A 114).

DA computing device 110 then uses secret value 216 to retrieve the at least one user data element 330. For example, DA computing device 110 includes a database engine 320 that retrieves the at least one user data element 330 identified by secret value 216 from database 116. Database engine 320 may filter the user data based on secret value 216, in order to obtain the selected at least one user data element 330.

DA computing device 110 transmits the at least one user data element 330 to relying party 130 as a response to the HTTP request. In the example embodiment, DA computing device 110 transmits the at least one user data element 330 over secure communication channel 148. Alternately, DA computing device 110 first encrypts (signs) the at least one user data element 330 using private key A 114, and then encrypts again using public key B 112, and sends the double-encrypted at least one user data element 330 to relying party computing device 130 over any suitable connection (e.g., an unsecured Internet connection). Relying party computing device 130 decrypts the at least one user data element 330 using first private key B 134 and then public key A 132. Alternately, DA computing device 110 uses any suitable combination of transmission channel and encryption to securely transmit the at least one user data element 330 to relying party computing device 130. Relying party computing device 130 then stores the at least one user data element 330 in memory 340.

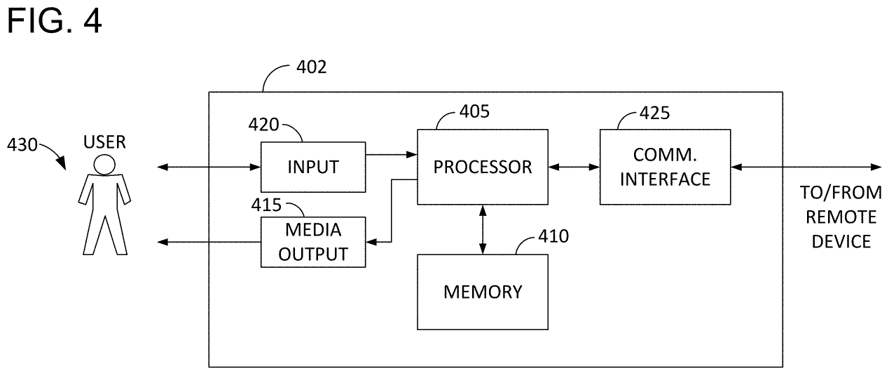

FIG. 4 depicts a user computing device 402 that may be used to implement user computing device 140 (shown in FIG. 1). Computing device 402 includes a processor 405 for executing instructions. In some embodiments, executable instructions are stored in a memory area 410. Processor 405 includes one or more processing units (e.g., in a multi-core configuration). Memory area 410 is any device allowing information such as executable instructions and/or other data to be stored and retrieved. Memory area 410 includes one or more computer-readable media.

Computing device 402 also includes at least one media output component 415 for presenting information to a user 430. Media output component 415 is any component capable of conveying information to user 430. In some embodiments, media output component 415 includes an output adapter, such as a video adapter and/or an audio adapter. An output adapter is operatively coupled to processor 405 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, media output component 415 is configured to present an interactive user interface (e.g., a web browser or client application) to user 430.

In some embodiments, computing device 402 includes an input device 420 for receiving input from user 430. Input device 420 includes, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 415 and input device 420.

Computing device 402 also includes a communication interface 425, which is communicatively coupleable to a remote device. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 430 via media output component 415 and, optionally, receiving and processing input from input device 420. A user interface may include, among other possibilities, a web browser and a client application. Web browsers enable users 430 to display and interact with media and other information typically embedded on a web page or a website from a web server. A client application allows users 430 to interact with a server application associated with data access computing device 110.

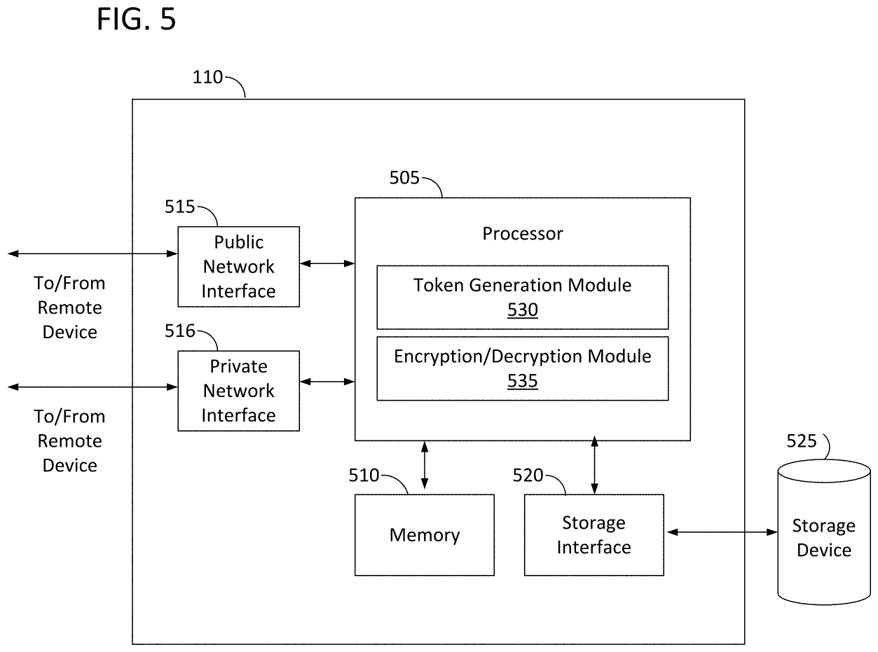

FIG. 5 depicts an exemplary configuration of data access computing device 110, shown in FIG. 1. Data access computing device 110 includes a processor 505 for executing instructions. Instructions are stored in a memory area 510, for example. Processor 505 includes one or more processing units (e.g., in a multi-core configuration).

In the example embodiment, processor 505 is operable to execute token generation module 530 and encryption/decryption module 535. Modules 530 and 535 may include specialized instruction sets, coprocessors, and/or kernel extensions. Token generation module 530 may generate secret values based at least in part on a random number generator, as shown FIG. 2. For example, token generation module 530 may include a hardware random number generator.

Encryption/Decryption module 535 is configured to encrypt and decrypt data based on public and/or private keys. For example, encryption/decryption module 535 may be used to encrypt secret value 216 as shown in FIG. 2. Further, encryption/decryption module 535 may be used to decrypt payload 310, as shown in FIG. 3. In one embodiment, encryption/decryption module 535 includes specialized processor instructions configured to encrypt/decrypt stored data (e.g., secret value 216, payload 310). In another embodiment, encryption/decryption module 535 may include an encryption/decryption optimized coprocessor connected to processor 505.

In the example embodiment, processor 505 is operatively coupled to a public network interface 515 and a private network interface 516 such that Data access computing device 110 is capable of communicating with remote device(s) user computing device 140 and/or relying party computing device 130. In some embodiments, network interface 515 and/or network interface 516 is a virtual interface, such as virtual private network (VPN) adapter. In certain embodiments, each of network interface 515 and network interface 516 is associated with a respective network address, such as an IP (“internet protocol”) address. In other embodiments, network interface 515 and/or network interface 516 are associated with physical network links. For example, network interface 515 may receive network packets from a user computing device 402 via Ethernet, using a switching device.

Processor 505 is operatively coupled to a storage device 525. Storage device 525 is any computer-operated hardware suitable for storing and/or retrieving data. In some embodiments, storage device 525 is integrated in Data access computing device 110. For example, data access computing device 110 may include one or more hard disk drives as storage device 525. In other embodiments, storage device 525 is external to Data access computing device 110 and is accessed by a plurality of host computing devices 502. For example, storage device 525 may include multiple storage units such as hard disks or solid state disks in a redundant array of inexpensive disks (RAID) configuration. Storage device 525 may include a storage area network (SAN) and/or a network attached storage (NAS) system.

In some embodiments, processor 505 is operatively coupled to storage device 525 via a storage interface 520. Storage interface 520 is any component capable of providing processor 505 with access to storage device 525. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 525.

Memory areas 410 (shown in FIG. 4) and 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

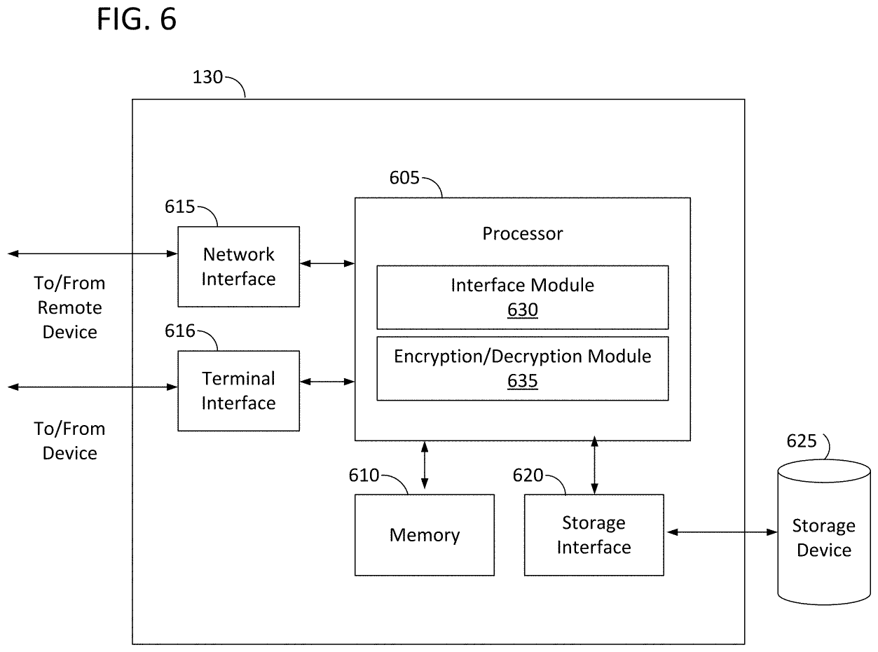

FIG. 6 depicts an exemplary configuration of relying party computing device 130, shown in FIG. 1. Relying party computing device 130 includes a processor 605 for executing instructions. Instructions are stored in a memory area 610, for example. Processor 605 includes one or more processing units (e.g., in a multi-core configuration).

In the example embodiment, processor 605 is operable to execute interface module 630 and encryption/decryption module 635. Modules 630 and 635 may include specialized instruction sets, coprocessors, and/or kernel extensions. In one embodiment, interface module 630 is a web server in communication with user computing device 140 (shown in FIG. 1). More specifically, interface module 630 may generate and transmit web pages to user computing device 140 over network interface 615. In another embodiment, interface module 630 is configured to receive user input from user terminals (e.g., point-of-sale terminals). Interface module 630 may communicate with any number of user terminals through terminal interface 616. For example, interface module 630 may receive a token value from a point of sale terminal. As another example, interface module 630 may control a point of sale terminal to display a QR code using terminal interface 616.

Encryption/Decryption module 635 is configured to encrypt and decrypt data based on public and/or private keys. For example, encryption/decryption module 635 may be used to decrypt encryption layer B 214 and encrypt nonce value 316, as shown in FIG. 3. In one embodiment, encryption/decryption module 635 includes specialized processor instructions configured to encrypt/decrypt stored data (e.g., secret value 216, payload 310). In another embodiment, encryption/decryption module 635 may include an encryption/decryption optimized coprocessor connected to processor 605.

In the example embodiment, processor 605 is operatively coupled to a public network interface 615 and a private network interface 616 such that Relying party computing device 130 is capable of communicating with remote device(s) user computing device 140 and/or relying party computing device 130. In some embodiments, network interface 615 and/or network interface 616 is a virtual interface, such as virtual private network (VPN) adapter. In certain embodiments, each of network interface 615 and network interface 616 is associated with a respective network address, such as an IP (“internet protocol”) address. In other embodiments, network interface 615 and/or network interface 616 are associated with physical network links. For example, network interface 615 may receive network packets from a user computing device 402 via Ethernet, using a switching device.

Processor 605 is operatively coupled to a storage device 625. Storage device 625 is any computer-operated hardware suitable for storing and/or retrieving data. In some embodiments, storage device 625 is integrated in Data access computing device 110. For example, relying party computing device 130 may include one or more hard disk drives as storage device 625. In other embodiments, storage device 625 is external to relying party computing device 130 and is accessed by a plurality of host computing devices 602. For example, storage device 625 may include multiple storage units such as hard disks or solid state disks in a redundant array of inexpensive disks (RAID) configuration. Storage device 625 may include a storage area network (SAN) and/or a network attached storage (NAS) system.

In some embodiments, processor 605 is operatively coupled to storage device 625 via a storage interface 620. Storage interface 620 is any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Memory area 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

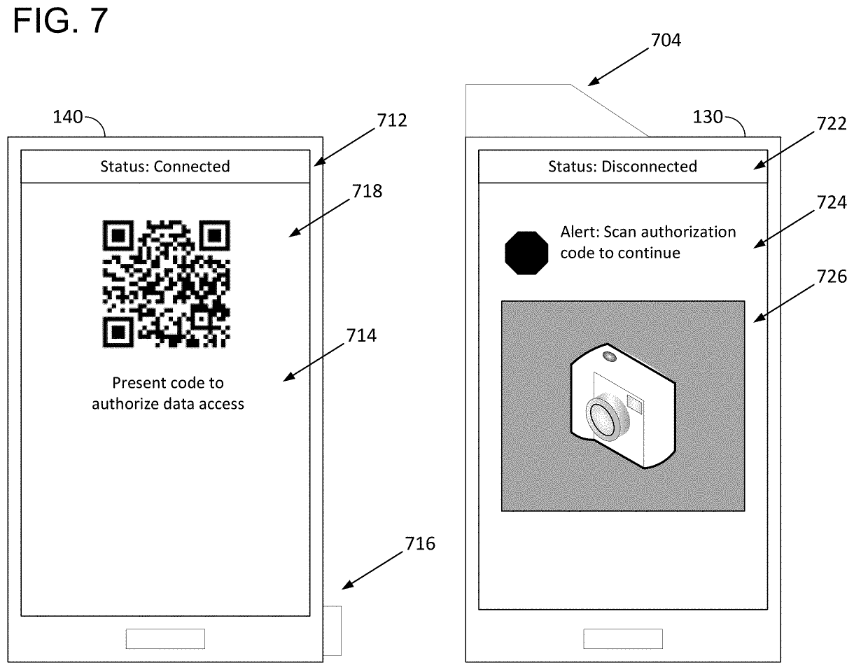

FIG. 7 is a schematic diagram illustrating an exemplary user device for the system shown in FIGS. 1-3. In one embodiment, sharing token 210 is transmitted from user computing device 140 to relying party 130 using a quick read (QR) code. User computing device 140 is operated by a user to generate QR code 718, which embodies sharing token 210 in an encoded form. Relying party 130 scans QR code 718 to receive sharing token 210. Sharing token 210 facilitates relying party 130 securely accessing at least one user data element. For example, relying party 130 may scan QR code 718 from user computing device 140 to accurately and securely retrieve a mailing and/or delivery address.

User computing device 140 is in communication with DA computing device 110 using wireless network interface 716 (e.g., Wi-Fi connection, cellular data connection), and displays connection indicator 712. User computing device 140 encodes sharing token 210 (shown in FIG. 2) as QR code 718, and displays prompt 714.

QR code 718 is configured to be captured as an image by relying party 130, and then decoded as sharing token 210. In the example embodiment, relying party 130 includes camera interface 704, such as a digital camera integrated with a mobile device. Connection indicator 722 may indicate relying party 130 is not connected to the internet and/or DA computing device 110. Prompt 724 indicates that access to user data is requested by relying party 130. Camera display 726 may be used to capture QR code 718 using camera interface 704. After QR code 718 is captured, relying party 130 is configured to decode and store sharing token 210 in memory 340 (shown in FIG. 3).

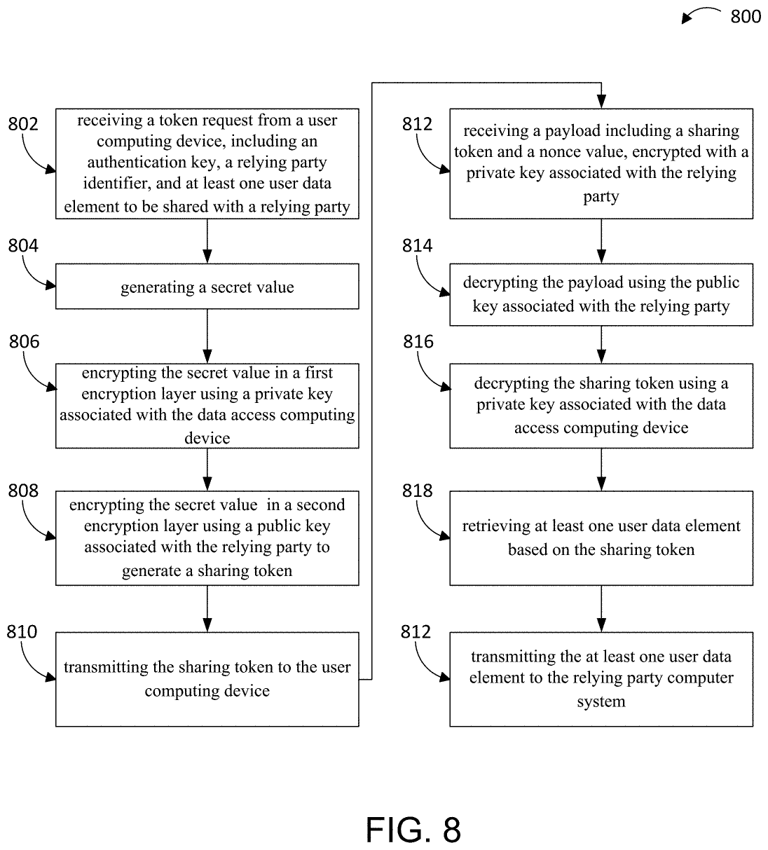

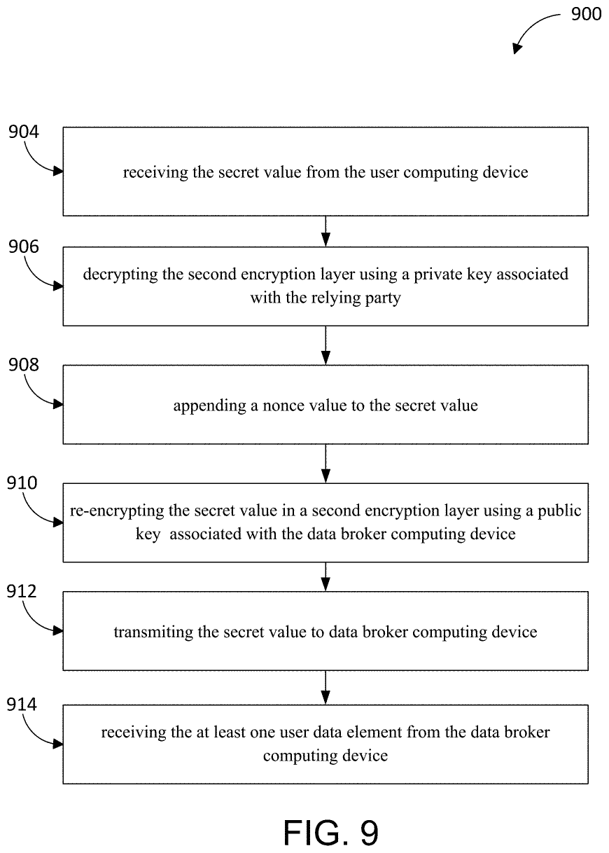

FIG. 8 is a flowchart illustrating an example method for generating a sharing token, which may be implemented using the data access system shown in FIG. 1. In the example embodiment, process 800 is implemented on data access computing device 110, shown in FIG. 1. Process 800 includes receiving 802 a token request from a user computing device, including an authentication key, a relying party identifier, and at least one user data element to be shared with a relying party. Process 800 further includes generating 804 a secret value unique to the token request, and encrypting 806 the secret value in a first encryption layer using a private key associated with the data access computing device. In other words, the first encryption layer is configured to authenticate the origin of the sharing value, and verify it was properly generated by the data access \cd. Process 800 further includes encrypting 808 the secret value in a second encryption layer using a public key associated with the relying party, such that the secret value is secured in transit to the relying party. For example, after step encrypting 808, the secret value may be transmitted securely over an otherwise unsecure network. Additionally, process 800 includes transmitting 810 the secret value, including the first and second encryption layers, to the user computing device. After process 800 (e.g., after the secret value is transmitted to the user computing device), relying party computing device 130 (shown in FIG. 1) may execute process 900 (shown in FIG. 9) to securely retrieve at least one user data element from data access computing device 110.

Process 800 further includes receiving 812 a payload including a sharing token and a nonce value, where the payload is encrypted with a private key associated with the relying party, The sharing token included in the payload may be further encrypted using a public key associated with the data access computing device. Process 800 includes decrypting 814 the payload using the public key associated with the relying party and decrypting 816 the sharing token using the private key associated with the data access computing device. In response to decrypting the sharing token, process 800 includes retrieving at least one user data element based on the sharing token, and transmitting the at least one user data element to the relying party computer system.

FIG. 9 is a flowchart illustrating an example method for retrieving at least one user data element using a sharing token, which may be implemented using the data access system shown in FIG. 1. In the example embodiment, process 900 is implemented on relying party computing device 130, shown in FIG. 1. Process 900 includes receiving 904 the secret value from the user computing device (e.g., user computing device 140, shown in FIG. 1), and decrypting 906 the second encryption layer using a private key associated with the relying party. In other words, process 900 includes receiving the secret value and removing the transport encryption. Process 900 further includes appending 908 a nonce value to the secret value, to prevent replay attacks and ensure the result sharing token is unique, and re-encrypting 910 the secret value in a second encryption layer using a public key associated with the data access computing device. In other words, re-encrypting 910 includes applying transport encryption to the sharing token, which may be decrypted by the data access computing device. Process 900 also includes transmitting 912 the secret value to a data access computing device (e.g., data access computing device 110, shown in FIG. 1), and receiving 914 the at least one user data element from the data access computing device, in response to transmitting 912.

As will be appreciated based on the foregoing specification, the above-described embodiments of the disclosure is implemented using computer programming or engineering techniques including computer software, firmware, hardware or any combination or subset thereof, wherein the technical effects described above are achieved. Any such resulting program, having computer-readable code means, is embodied or provided within one or more computer-readable media, thereby making a computer program product, (i.e., an article of manufacture), according to the discussed embodiments of the disclosure. The computer-readable media is, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code is made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A data access computing device comprising a processor in communication with a database, wherein the database stores a plurality of user data elements associated with a user, the processor programmed to:
receive a token request from a user computing device, the token request including an authentication key, wherein the token request identifies (i) a relying party and (ii) at least one user data element of the user to be shared with the relying party;
generate, in response to validating the authentication key, a secret value unique to the token request;
associate, in the database, the secret value with the at least one user data element;
encrypt the secret value in a first encryption layer using a private key A associated with the data access computing device to generate an A-encrypted secret value;
encrypt the A-encrypted secret value in a second encryption layer using a public key B associated with the relying party to generate a sharing token;
transmit the sharing token to the user computing device;
receive a payload encrypted using a private key B associated with the relying party from a relying party computing device, wherein the payload includes the A-encrypted secret value and a nonce value, and wherein the private key B is complementary to the public key B;
decrypt the payload using the public key B to recover the nonce value and the A-encrypted secret value;
decrypt the A-encrypted secret value using a public key A to recover the secret value, wherein the public key A is complementary to the private key A;
retrieve the at least one user data element from the database based on the secret value; and
transmit the at least one user data element to the relying party computing device.

2. The data access computing device of claim 1, wherein the processor is further programmed to verify that the received payload has not already been processed by comparing the nonce value to a plurality of previously received nonce values.

3. The data access computing device of claim 1, wherein the nonce value includes a time stamp generated by the relying party computing device, and wherein the processor is further programmed to verify that the payload is not stale by comparing the time stamp from the nonce value against a time of receipt of the payload by the DA computing device.

4. The data access computing device of claim 1, wherein the token request includes an expiration time, and wherein the processor is further programmed to validate the recovered secret value against the expiration time.

5. The data access computing device of claim 1, wherein the secret value is not associated in the database with others of the plurality of user data elements of the user, such that the secret value is usable by the relying party to obtain solely the at least one user data element identified in the token request.

6. The data access computing device of claim 1, wherein the processor is further programmed to provide the authentication key to the user computing device in response to the user logging in to one of (i) a mobile application associated with the data access computing device and executing on the user computing device, and (ii) a website associated with the data access computing device.

7. A computer-implemented method for secure data transmission, said method implemented using a data access computing device including a processor in communication with a database, said method comprising:
receiving a token request from a user computing device, the token request including an authentication key, wherein the token request identifies (i) a relying party and (ii) at least one user data element of the user to be shared with the relying party;
generating, in response to validating the authentication key, a secret value unique to the token request;
associating, in the database, the secret value with the at least one user data element;
encrypting the secret value in a first encryption layer using a private key A associated with the data access computing device to generate an A-encrypted secret value;
encrypting the A-encrypted secret value in a second encryption layer using a public key B associated with the relying party to generate a sharing token;
transmitting the sharing token to the user computing device;
receiving a payload encrypted using a private key B associated with the relying party from a relying party computing device, wherein the payload includes the A-encrypted secret value and a nonce value, and wherein the private key B is complementary to the public key B;
decrypting the payload using the public key B to recover the nonce value and the A-encrypted secret value, and decrypting the A-encrypted secret value using a public key A to recover the secret value, wherein the public key A is complementary to the private key A;
retrieving the at least one user data element from the database based on the secret value; and
transmitting the at least one user data element to the relying party computing device.

8. The method of claim 7, further comprising verifying that the received payload has not already been processed by comparing the nonce value to a plurality of previously received nonce values.

9. The method of claim 7, wherein the nonce value includes a time stamp generated by the relying party computing device, the method further comprising verifying that the payload is not stale by comparing the time stamp from the nonce value against a time of receipt of the payload by the DA computing device.

10. The method of claim 7, wherein the token request includes an expiration time, the method further comprising validating the recovered secret value against the expiration time.

11. The method of claim 7, wherein the secret value is not associated in the database with others of the plurality of user data elements of the user, such that the secret value is usable by the relying party to obtain solely the at least one user data element identified in the token request.

12. The method of claim 7, further comprising providing the authentication key to the user computing device in response to the user logging in to one of (i) a mobile application associated with the data access computing device and executing on the user computing device, and (ii) a website associated with the data access computing device.

13. A non-transitory computer readable storage media having computer-executable instructions embodied thereon, wherein when executed by a data access computing device having a processor coupled to a database, the computer-executable instructions cause the processor to:
receive a token request from a user computing device, the token request including an authentication key, wherein the token request identifies (i) a relying party and (ii) at least one user data element of the user to be shared with the relying party;
generate, in response to validating the authentication key, a secret value unique to the token request;
associate, in the database, the secret value with the at least one user data element;
encrypt the secret value in a first encryption layer using a private key A associated with the data access computing device to generate an A-encrypted secret value;
encrypt the A-encrypted secret value in a second encryption layer using a public key B associated with the relying party to generate a sharing token;
transmit the sharing token to the user computing device;
receive a payload encrypted using a private key B associated with the relying party from a relying party computing device, wherein the payload includes the A-encrypted secret value and a nonce value, and wherein the private key B is complementary to the public key B;
decrypt the payload using the public key B to recover the nonce value and the A-encrypted secret value;
decrypt the A-encrypted secret value using a public key A to recover the secret value, wherein the public key A is complementary to the private key A;
retrieve the at least one user data element from the database based on the secret value; and
transmit the at least one user data element to the relying party computer system.

14. The computer-executable instructions of claim 13, wherein the computer-executable instructions, when executed by a relying party computing device having at least one processor coupled to at least one memory device, the computer-executable instructions cause the at least one processor to verify that the received payload has not already been processed by comparing the nonce value to a plurality of previously received nonce values.

15. The computer-executable instructions of claim 13, wherein the nonce value includes a time stamp generated by the relying party computing device, and wherein the computer-executable instructions further cause the at least one processor to verify that the payload is not stale by comparing the time stamp from the nonce value against a time of receipt of the payload by the DA computing device.

16. The computer-executable instructions of claim 13, wherein the token request includes an expiration time, and wherein the computer-executable instructions further cause the at least one processor to validate the recovered secret value against the expiration time.

17. A relying party computing device comprising at least one processor in communication with a memory, the at least one processor programmed to:
request at least one user data element from a user;
receive a sharing token from a user computing device associated with the user, the sharing token including a secret value encrypted in a first encryption layer using a private key A associated with a data access computing device, and in a second encryption layer using a public key B associated with the relying party computing device;
decrypt the sharing token using a private key B to recover to the A-encrypted secret value, wherein the private key B is complementary to the public key B;
generate a nonce value;
encrypt the A-encrypted secret value and the nonce value together using the private key B to generate a payload;
transmit the payload to the data access computing device; and
receive, in response to the transmission of the payload, the at least one user data element.

18. The relying party computing device of claim 17, further comprising a camera interface configured to scan a quick read code embodying the sharing token.

19. The relying party computing device of claim 17, wherein the at least one processor is further programmed to transmit a webpage to the user computing device, wherein the webpage is configured to cause the user computing device to obtain the sharing token and transmit the sharing token to the relying party computing device.

20. The relying party computing device of claim 17, wherein the at least one processor is further programmed to transmit a webpage to the user computing device, wherein the webpage includes an interactive form field configured to receive the sharing token.
